(19) United States
(12) Patent Application Publication
(10) Pub. No.: US 2009/0055259 A1
(43) Pub. Date: Feb. 26, 2009

(54) Lost key rewards system and method

(76) Inventor: Marla Lavoice, (US)

Correspondence Address: LAW OFFICES OF CAROL N. GREEN, P.A., SUITE 2750, 200 S. BISCAYNE BLVD., MIAMI, FL, 33131, US

(21) Appl. No.: 11/894,347

(22) Filed: Aug. 21, 2007

(51) Int. Cl. G06Q 30/00; G06F 17/30; G06Q 99/00

(52) U.S. Cl. 705/14; 705/1

(57) ABSTRACT

A lost key rewards system and method which allows key owners to register their keys with a central database accessible by a world wide website portal where the key owner's contact information is kept private and confidential. In particular, the lost key rewards system and method utilize an encoded key tag, each with a unique key tag number that a key tag owner may attach to their keychain or key ring. The key tag also has instructions for accessing a specified website and forwarding the found key tags for a reward. A key tag owner may participate in the program by registering their key tag with its unique key tag number along with their contact information. Thus, if the key tag owner's keys and key tag are lost and found, the key tag finder has a system and method of returning the keys to the key tag owner and may choose to receive a reward. This lost key rewards system and method also provides the opportunity for large or small corporations to incorporate the key retrieval system as an employee and/or customer reward program.

### FIELD OF THE INVENTION

The present invention is directed to a computer implemented lost key rewards system and method which comprises of a central electronic database providing for the confidential registration of a key owner's contact information to facilitate the return of lost keys while providing for a rewards program for a key tag finder as well as an e-commerce method of purchasing key tags using the system and method of the invention.

### BACKGROUND OF THE INVENTION

Invariably, key owners will lose their keys for automobiles, homes, boats, motorcycles, businesses, elevator fabs, safety deposit boxes, post office boxes, etc. Such a loss may occur anywhere, for example in the home, airports, hotels, or even in a different state. However, depending on the type of keys, duplicating keys can be quite difficult and costly. For example, certain automotive keys that contain electronically stored data cost anywhere from $300 to as much as $1,500 to replace. The replacement process may also include verifying title and registration and a significant wait. In addition, having a duplicate set of keys does not guarantee that both the original and the duplicate keys won't be simultaneously lost.

Moreover, depending on where the keys are lost, there might be an issue of compromised security. For example, if the loss occurs outside the comfort of one's home, then the challenge becomes finding the keys before further loss, break-ins and/or theft occurs. Generally, a key owner will conduct a comprehensive search for the lost keys while invariably hoping that he or she finds the keys prior to incurring further loss or costs from a locksmith. Thus, the key owner hopes that a benevolent key finder finds and returns the lost keys.

However, in order for a key finder to return the found keys, the key finder will need the key owner's address and contact information which for obvious security reasons cannot be in the public domain. As such, a benevolent key finder may have the desire to return the found keys but may not have the appropriate contact information to be able to do so. Further, on occasion, a key finder may realize that the keys are pretty valuable and would like to be compensated for finding and returning the lost keys. The alternative is also true, that a key owner may be grateful that the keys have been found and wish to reward the key finder. However, without an exchange of the pertinent contact information for the key finder or key owner, the intent will be frustrated for lack of information.

Thus, there exists a need for a system and method for returning found keys to their rightful key owners regardless of whether their contact information is in the public or private domain. In addition, there exists a need for a system and method available to key owners to register their contact information on a confidential basis such that if their keys are ever lost and found, a key finder will have a method of returning the keys without the key owner's confidential information and security being compromised. There also exists a need to fund this lost key rewards system and method.

Similarly, there exists a need for both key owners and key finders to have universal access to a central electronic database such that key owners may register their keys to facilitate their return, regardless of where they are found. There also exists a need to allow for a rewards program for key finders which provides for the anonymity of the key owner and/or the key finder.

Many corporations are looking for cost effective ways of promoting their business and increasing the level of customer satisfaction. As the amount of in person contact decreases, businesses have shifted to finding new and innovative services to offer their customers to maintain a competitive edge to resolve that issue. Often, the promotional materials or gimmicks available for giveaways, although attractive, have minimal use to the customer. In addition, these promotional materials can be costly without yielding a sufficient return on the investment. Thus, there is a need for businesses to have a system and method for marketing and advertising their business to improve their customer's satisfaction with the services being offered.

### SUMMARY OF THE INVENTION

An objective of the present invention is to provide a lost key rewards system and method for all types of keys so that when a key is lost, the key owner can be readily identified and reunited with their keys in an inexpensive, efficient and effortless manner.

Another objective of the invention is to provide a confidential database for key owners where their contact information is kept private and confidential. In that event, if keys are lost and found, their keys can be returned without disclosure of the key owner's private contact information.

Another objective of the invention is to allow key owners who subscribe to the lost key rewards system and method to receive an encoded key tag with a unique key tag number to add to their key chain, where the key tag has specific instructions and reward incentives for the key tag finder who finds and returns the lost keys.

Another objective of the invention is to provide a method of doing business where the key tags are sold for a profit which funds the lost key rewards system and method.

Another objective of the invention is to provide a system and method for key tag finders to notify a key owner that their lost keys were found.

Another objective of the invention is to provide a system and method for key tag finders to remain anonymous in the event they find the lost keys.

Embodiments provide a system, method, apparatus, means, and computer program code to accomplish these objectives, as the invention uses the Internet to allow global access to a website which has a central electronic database specifically designed to store a key owner's information on a confidential basis. A subscribing member of the lost key rewards system and method can elect to purchase a key tag to add to their key chain or ring, whereby each key tag has a unique key tag number that contains coded information used to identify the key tag owner. It is understood that the key tag of the invention may be attached to not just keys, but may include elevator fabs, access cards or any other objects that would ordinarily be stored on a key ring or key chain. In one embodiment of the invention, the key tag has a locator tracking device embedded in the key tag that is traceable through a Global Positioning System (“GPS”) such that when a key tag owner loses his or her keys, the locator tracking device may be activated for that key tag, such that the keys can be located.

The systems, methods, apparatus, means, and computer program code described herein allow key tag owners to register their contact information with the database of the invention, i.e. name, address, credit card information for purchases, membership, renewals, reactivation or key tag return fees. The system of the invention has instruction code designed to further track statistics concerning the key tags, including but not limited to how many keys tags are lost, stolen, active, inactive, expired, renewable, reactivated, etc. The key tag also has information directing the finder of the lost keys and as to where to deposit and mail the lost keys for its return. A key tag owner may choose to report their lost keys to the lost key rewards system to facilitate their return or they may decide reporting the lost keys is unnecessary for varied reasons. However, the keys may still be returned to the key tag owner even though the key tag owner did not report the keys as stolen or lost, but the system of the invention will report the key tag in the status it was before the keys were lost or stolen. Accordingly, if a key tag owner loses their keys, the key tag owner's information is kept private and confidential but a key tag finder will have a system and method of reuniting the key tag owner with their lost keys.

The lost key rewards system and method also provides for the purchase of additional key tags, whether for the key tag owner's personal use or as a gift, as well as the ability for the key tag owner to manage their account and key tag membership. In one embodiment of the invention, key tag owners are charged a nominal fee for key tag membership, which is renewable each year. In the preferred embodiment, the key tag owner is granted a thirty day grace period before reactivation fees are assessed. In alternate embodiments of the invention, key tag membership is free, but the reactivation, membership renewal or the key tag return fee will be charged to the key tag owner.

According to the system and method of the invention, if a key tag owner purchases a key tag for themselves or as a corporate customer, unless the key tag has been replaced, the key tag will remain registered to the individual key tag owner even after the key tag has expired. Thus, if a key tag is found after its membership has expired, i.e. beyond one year and thirty days, the key tag owner may still be identified and notified of the found keys. The key tag owner can then elect as to whether or not they wish to have the keys returned with the payment of a renewal and/or reactivation fee.

Another objective of the invention is to allow corporations to incorporate the lost key rewards system and method as part of their employee or customer reward and incentive programs, while deriving profit without much expenditure.

Another objective of the invention is to provide a corporate entity with the means to advertise their company's logo and contact information on corporate key tags such that the corporate entity is establishing brand identity, marketing their goods and/or services while improving customer satisfaction.

To accomplish these business objectives, the lost key rewards system and method provides for a partnership with corporate entities. One of the benefits of partnership is allowing corporate customers to purchase key tags at a discounted rate where the key tags may be customized with the company logos and/or targeted messages; to receive corporate newsletters; and/or enjoy other promotional programs that are specifically geared for their corporate customers. By purchasing the key tags at a discounted rate, the corporate entity may either pass on the savings to the corporate customers or derive revenue by charging the corporate customers full price. In an alternate embodiment of the invention the corporate entity may purchase and distribute the key tags as a gift or part of their rewards program to their corporate customers without deriving any profit form the sale and/or distribution.

In an alternate embodiment, the corporate entity may distribute a corporate passcode for their corporate customers' use while the lost key rewards system and method handles the administration of the program. The corporate customers may then access the lost key rewards system and method, enter their corporate passcode and/or purchase a key tag.

For a further and more fully detailed understanding of the present invention, various objects and advantages thereof, reference is made to the following detailed description and the accompanying drawings.

### BRIEF DESCRIPTION OF THE DRAWINGS

Further objectives and advantages of the present invention may be derived by referring to the detailed description and claims when considered in connection with the Figures, wherein like reference numbers refer to similar items throughout the Figures.

FIG. 1A is network diagram that illustrates an embodiment of the system of the invention.

FIG. 1 is a schematic illustration of the e-commerce transaction of purchasing a key tag using the invention.

FIG. 2 is a schematic illustration of an e-commerce transaction for purchasing key tags as a gift using the invention.

FIG. 2A is a schematic illustration of the varied functions that a key tag purchaser may perform after purchasing a key tag as a gift using the invention.

FIG. 3 is a schematic illustration of the varied functions that a corporate customer may perform using the invention.

FIG. 4 is a schematic illustration of e-advertising to generate e-commerce transactions using the invention.

FIG. 5 is a schematic illustration of the varied functions that an individual key tag owner may perform using the invention.

FIG. 6 is a schematic illustration of how to report lost keys using the invention.

FIG. 7 is a schematic illustration of how to check the status of lost keys using the invention.

FIG. 8 is a schematic illustration of the method for the return of found keys using the invention.

FIG. 9 is a schematic illustration of how to renew a key tag membership using the invention.

FIG. 10 is a schematic illustration of how to reactivate an expired key tag using the invention.

FIG. 11 is a schematic illustration of how to request a replacement key tag using the invention.

FIG. 12 is a schematic illustration of how to invite friends to become members using the invention.

FIG. 13 is a schematic illustration of how a key tag owner may update their contact information using the invention.

FIG. 14 is a schematic illustration of how a key tag owner may cancel their key tag membership using the invention.

FIG. 15 is a schematic illustration of how to report found keys using the invention.

FIG. 16 is a schematic illustration of how a key tag owner may update their credit card information and membership information using the invention.

### DESCRIPTION OF PREFERRED EMBODIMENTS

The present invention is now described in more detail by reference to the exemplary drawings in detail wherein like numerals indicate like elements throughout the various views. This is for convenience only and is not intended to limit the application of the present invention. In fact, after reading the following description, it will be apparent to one skilled in the relevant art(s) how to implement the following invention in alternate embodiments.

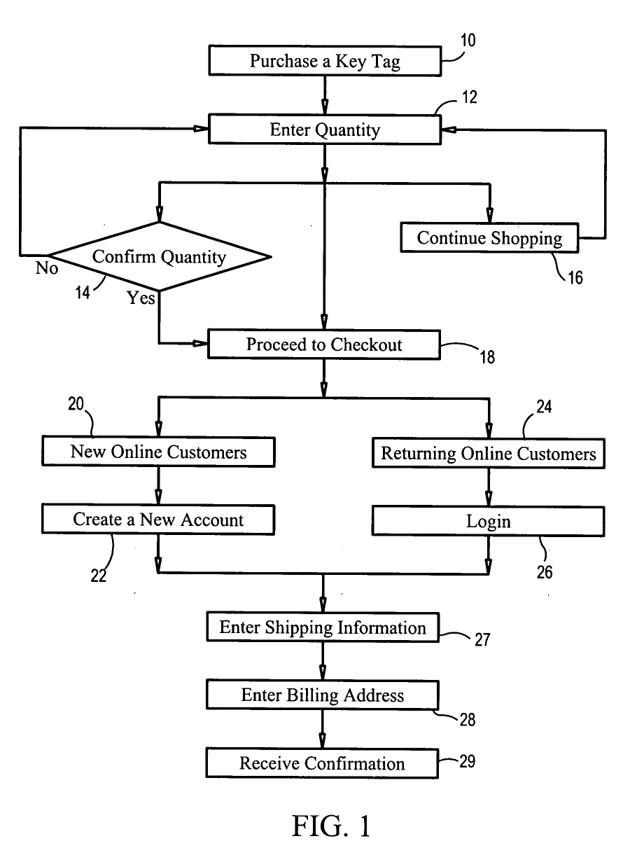

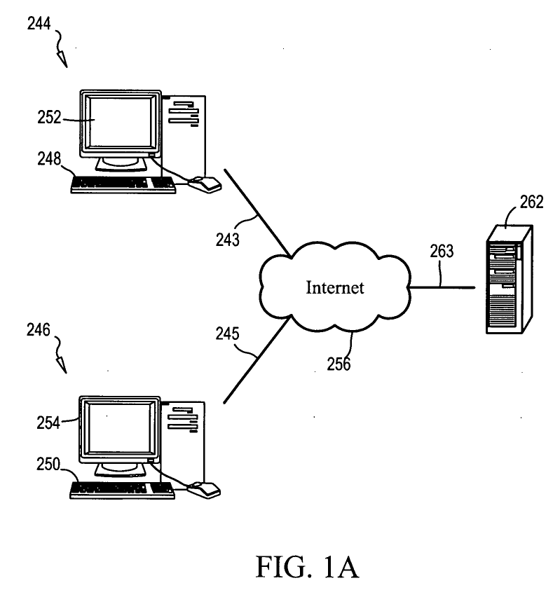

FIG. 1A is network diagram that illustrates an exemplary embodiment of the system of the invention. A customer may access the system of the invention via Internet 256 by way of communication paths 243, 245 using their web access device, e.g. game boy, PDAs, I-Phones, or personal computer 244, 246 which has a keyboard 248, 250 and monitor 252, 254 for entering and displaying information. When a customer accesses the lost key rewards system via the Internet 256 which is in communications with the server 262, the system of the invention may communicate with the lost key rewards customer via a similar communication path 263 as previously described. Said communication paths 243, 245 may include but is not limited to wireless transmissions, fiberoptics, radio frequency transmissions, or any other communication paths that are well known and used in the arts to communicate with the Internet 256. The server 262 environment of the invention also comprises of a an operating system 258 (not shown), a central processor 242 (not shown) and a memory device 260 (not shown) where the central electronic database is used to store information concerning each key tag, the key tag owner, credit card information, membership status information and the like, as discussed in further detail below.

The memory device may be any computer-readable media such as storage devices, such as a hard drive, a CD-ROM, and/or floppy disk drive, flash drives or any other media devices as used in the arts and may contain instruction code for implementing the lost key reward system are well known and used in the arts. The central processor 242 (not shown) of server 262, is in further communications with a central electronic database which is a part of the memory device 260 (not shown). The central processor 260 (not shown) is configured to perform the following activities which may include but is not limited to performing e-commerce transactions, receiving and storing data, performing searches, etc. Also, one skilled in the art will appreciate that various communication channels can be used to interconnect the web server and the customers' personal computer 244, 246 such as the Internet 256, a wide area network, or point-to-point, dial-up connections.

FIG. 1 is a schematic illustration of the e-commerce transaction of purchasing a key tag using the invention. A customer may access the lost key rewards system and method via a world wide website portal (Step 8, not shown) designed to perform inter alia, the e-commerce transaction of purchasing a key tag as in Step 10. As in any e-commerce transaction involving a quantitative sale, the customer must select the quantity for purchase as in Step 12 and the system of the invention will tabulate the cost for the quantity selected. In one embodiment of the invention, there is a cost incentive for purchasing multiple key tags, e.g. buy 3, get 1 free. In another embodiment of the invention, the customer may enter a promotional code (Step 6, not shown) to receive a discount on the key tag(s) being purchased. In an alternate embodiment of the invention, the key tag owner purchased the key tag from a storefront or received the key tag as a gift. In other embodiments, the corporate entity purchases the key tag and distributes the purchased key tag to its corporate customers. In these embodiments, the key tag will have a temporary password for logging in to the lost key rewards system. Thereafter, the key tag owner may add all their contact and credit card information.

If the customer is satisfied with the quantity selected, the customer may proceed directly to checkout their purchases as in Step 18, or continue shopping as in Step 16, in which event the customer will return to Steps 12-18. If the customer is dissatisfied with the quantity selected, the customer may confirm their purchase as in as in Step 14, which may involve the removal of key tags from the shopping cart (Step 13, not shown), or editing the quantity selected (Step 15, not shown) to either increase or decrease the number of key tags being purchased.

Once the customer is ready to checkout as in Step 18, if this is a new online customer, additional information will be required in order to consummate the sale, i.e. the customer must register their contact information with the central electronic database of the invention. As such, the customer must identify him or herself to the central electronic database as a new online customer as in Step 20 and the customer will be required to create a new account as in Step 22. To create a new account (Step 22) the new online customer will need to provide at a minimum, their name, address, mailing address, telephone numbers, and e-mail address. In addition, all new customers will be required to create a unique userid and password that will be used to authenticate the customer for subsequent logins via a password verification system that is well known and used in the arts.

In one embodiment of the invention, in creating a new account the customer is prompted to provide the email addresses of friends that they would like to invite to join (Step 90, not shown) the lost key rewards system and method. In yet another embodiment of the invention, the customer is polled for marketing and/or demographic information, e.g. the referral source, age, entertainment preferences, etc.

If the customer is a returning customer, the customer must identify themselves as such, as in Step 24, and will need to login as in Step 26 using the password verification system to access their saved information. Once the customer has either completed the creation of a new account (Step 22) or logged in (Step 26) as a returning customer, they may proceed to enter their shipping information (Step 27), e.g. name, shipping address, express, first class, priority or any other type of mail delivery service. In one embodiment of the invention, the customer can elect to renew their automatic subscription (Step 190, not shown) with the lost key rewards system and method as they provide their shipping and/or billing information. If the billing information differs from the shipping information, as is customary, the customer must provide the billing information as in Step 28. The billing information would include, inter alia, name, type of credit card name, billing address, expiration date, etc. and other like information for e-commerce transactions. Once Steps 27-28 are complete, the customer may proceed to receive confirmation (Step 29) of the purchase order.

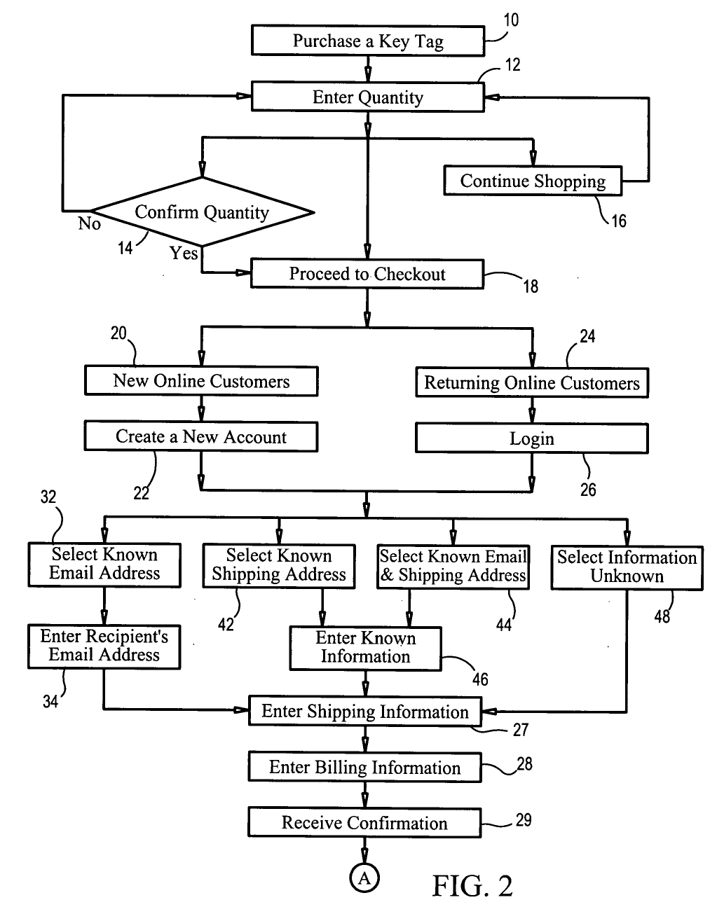

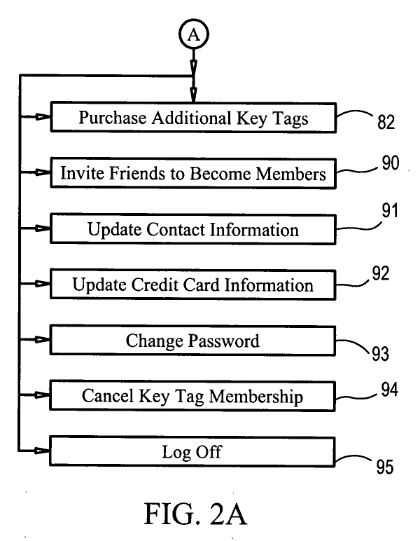

FIG. 2 is a schematic illustration of an e-commerce transaction for purchasing key tags as a gift using the invention. Any customer, new or returning, may access the lost key rewards system and method as in Step 8 (not shown) via the website to purchase key tags as a gift (Step 11, not shown) for a third-party. The customer will be prompted to repeat Steps 10-26 of FIGS. 1 & 2. In addition, the customer must provide a shipping address for the gift. However, it is not unusual that a gift donor has limited or no address information for a gift recipient. The invention provides for such contingencies as it allows the donor to provide known information from which there is a means for informing the third party gift recipient, or in the alternative have the gift key tag(s) shipped directly to the donor for delivery. The system of the invention is configured to receive contact information for a third party and provide the means for delivery to the third party gift recipient.

For example, if the donor knows only the email address for the gift recipient, the donor may select the option for known email address as in Step 32, proceed to enter the gift recipient's email address as in Step 34 and enter the shipping information as in Step 27, which may include, but is not limited to the donor's address, type of shipping method, etc. Thereafter, the donor may enter the billing information (Step 28) if different from the shipping address. Once Steps 27-28 are complete, the donor may proceed to receive confirmation (Step 29) of the purchase order. In one embodiment of the invention, the gift recipient is notified by email of the gift and/or the identity of the donor. In the preferred embodiment, the gift recipient is notified of the gift and is provided with a temporary userid and password such that the gift recipient may access the website (Step 8, not shown) and provide their own contact information to receive the gift key tag or to perform other select functions that a key tag owner may perform as a member of the lost key rewards system and method as seen in FIG. 2A.

FIG. 2A is a schematic illustration of the varied functions that a donor may perform after purchasing a gift key tag using the invention. For example, the donor may purchase additional key tags as in Step 82; invite friends to become members as in Step 90; update their contact information as in Step 91; update their credit card information as in Step 92; change their password as in Step 93; cancel their key tag membership as in Step 94; or logoff as in Step 95.

Referring back to FIG. 2, if the donor knows the shipping address of the gift recipient, or both the email and shipping address of the gift recipient, the donor may select the applicable option as in Step 42 (select known shipping address) or Step 44 (select known email and shipping address), respectively, and proceed to enter the gift recipient's known information as in Step 46 which may also include the gift recipient's telephone number. Additionally, the donor will need to enter the shipping and billing information, if different as in Steps 27-28, respectively. Once the shipping and billing information is verified, the donor may receive confirmation (Step 29) of the purchased gift key tags.

If the donor has no address information for the gift recipient, i.e. neither email nor a shipping address, the donor must select the option that information is unknown as in Step 48, and enter their own shipping and billing information as in Steps 27-28, or some other appropriate shipping and billing information for the receipt of the gift. Once the donor verifies the shipping and billing information, the donor may receive confirmation (Step 29) of the purchased gift key tags.

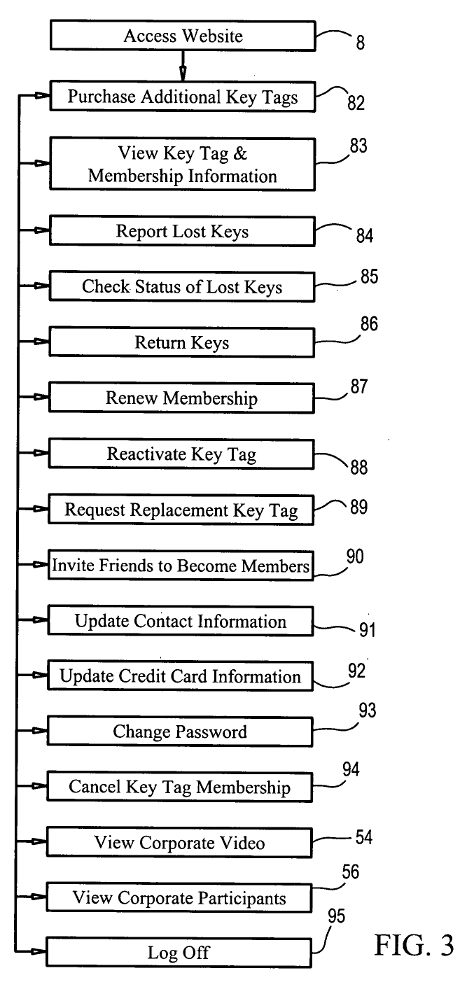

FIG. 3 is a schematic illustration of the varied functions that a corporate customer may perform using the invention. The corporate rewards program allows a corporate entity to partner with the lost key rewards system and method such that their corporate customers can participate as members. In one embodiment of the invention, the corporate entity may purchase a select number of key tags, possibly at a discount for distribution to their employees, existing or potential customers (collectively “corporate customers”). In one embodiment, the corporate entity distributes free key tags to their corporate customers with a temporary password for each key tag that is distributed for login to the lost key rewards system. There, the corporate customer may or may not have to enter their contact information depending on whether the corporate entity has already provided the same to the lost key rewards system.

In another embodiment of the invention, the corporate entity distributes a corporate passcode to its corporate customers that is unique to that corporate entity. The corporate passcode serves to identify these corporate customers to the lost key rewards system and method such that they can receive any negotiated promotional corporate rate for their key tag purchases, customized corporate information and updates, e.g. newsletters, and any other promotional or advertising materials specifically tailored for those corporate customers.

Once the corporate customer has accessed the website as in Step 8, the corporate customer may: login using the corporate passcode (Step 13, not shown); purchase a key tag (Step 10, not shown); purchase additional key tags (Step 82) for either themselves or as a gift; view their key tag membership information (Step 83); report lost keys (Step 84); check status of lost keys (Step 85); return their keys (Step 86); renew their membership with the lost key rewards system and method (Step 87); reactivate an expired key tag (Step 88); request replacement key tag for damaged key tag (Step 89); invite friends to become members (Step 90); update their contact information (Step 91); update credit card information (Step 92); change their password (Step 93); cancel their key tag membership (Step 94); view corporate video (Step 54); view other corporate participants (Step 56); or logoff (Step 95).

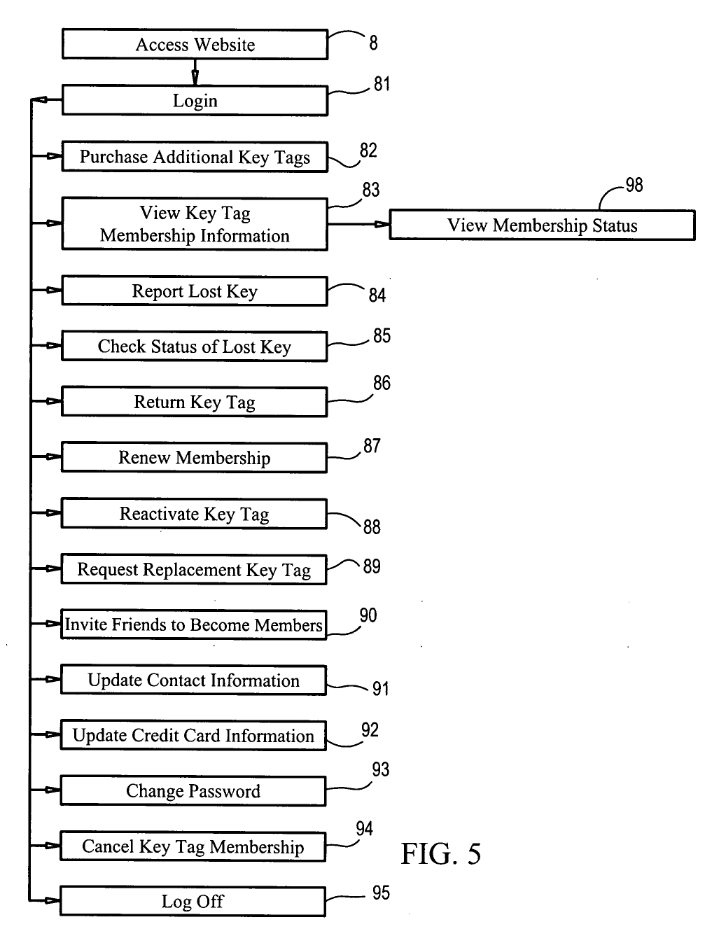

These steps will be explained in further detail below in conjunction with FIG. 5 which illustrates the varied functions that an individual key tag owner may perform using the invention as like referenced numbers refer to similar items throughout. However, unlike individual key tag owners, corporate entities that have partnered with the lost key rewards system and method may view a corporate video as in Step 54 of FIG. 3 which contains customized promotional and marketing information for that corporate entity, e.g. corporate rates, discounts, amounts purchased, or any other confidential information, that their corporate customers would not be privy to. In the preferred embodiment access to the corporate video is limited to an “as needed basis,” i.e. Marketing Executive(s), Vice Presidents and/or Chief Operating Officer, where these select individuals must have a specific passcode which will be verified by the system of the invention prior to their gaining access to the confidential information. Any lost key rewards existing or potential customer, including an individual or corporate customer, may access the website Step 8 and view a list of other corporate participants (Step 56 of FIG. 3) who have partnered with the lost key rewards system and method. In that embodiment, the lost key reward customer need not have logged in using the corporate passcode (Step 13, not shown) to the system of the invention.

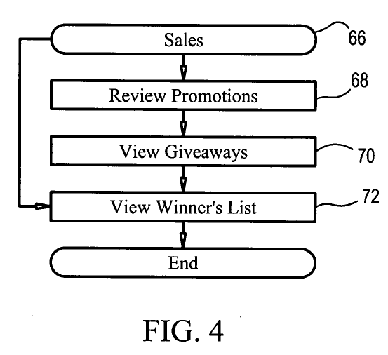

FIG. 4 is a schematic illustration of e-advertising to generate e-commerce transactions using the invention. The lost key rewards system and method endeavors to be all encompassing by providing the means for e-commerce transactions, e-marketing and e-advertising using the invention. In that regard, on occasion the lost key rewards system and method will have varied sales promotions in which the key tag owners can participate to win varied prize giveaways. In one embodiment of the invention, the key tag owner may select the sales option as in Step 66, review promotions as in Step 68 and view the available prize giveaways as in Step 70. In this embodiment of the invention, all key tag owners are eligible for a random periodic drawing and as such, no further action is needed for a key tag owner to participate as an entrant in the giveaways.

In another embodiment of the invention, if the key tag owner wishes to participate in the promotional giveaways, after viewing the prize giveaways as in Step 70, the key tag owner must enter their key tag number as in Step 71 (not shown) for the random drawing. Notwithstanding, in both of these embodiments, the system of the invention will randomly select a winner from the entrants and notify the key tag owner/winner that they have won a prize. In doing so, the key tag owner can be contacted and their picture and/or other information uploaded to the lost key rewards system and method for publication on the winner's list. To learn if a key tag owner won a prize, the key tag owner simply views the winner's list as in Step 72 where the winner's name would be published.

FIG. 5 is a schematic illustration of the varied functions that an individual key tag owner may perform using the invention. After accessing the website as in Step 8, and logging in (Step 81), a key tag owner may purchase additional key tag(s) (Step 82) for either themselves or as a gift; view their membership information (Step 83); view their key tag membership information (Step 83); report lost keys (Step 84); check status of lost keys (Step 85); return their keys (Step 86); renew their membership with the lost key rewards system and method (Step 87); reactivate an expired key tag (Step 88); request replacement key tag for damaged key tag (Step 89); invite friends to become members (Step 90); update their contact information (Step 91); update credit card information (Step 92); change their password (Step 93); cancel their key tag membership (Step 94); or logoff (Step 95).

As mentioned, if a key tag owner wishes to purchase additional key tags as in Step 82, the key tag owner will need to provide the system of the invention with the quantity, shipping and billing information to complete this e-commerce transaction and follow the Steps enumerated in Steps 10-29 of FIG. 1.

As seen in FIG. 5, a key tag owner may view their membership information Step 83 using the invention. Once the key tag owner submits the request to view their key tag membership information (Step 83) to the system of the invention, the system of the invention will display all key tags owned by that key tag owner identifying each key tag by its unique key tag number. The key tag owner may then view the membership status information as in Step 98 which may comprise of such information as the key tag number, the expiry date for the key tags, renewal dates for membership, reactivation dates and/or the status of each key tag, i.e. active, lost, stolen or cancelled. For example:

| Key Tag | | | Reactivation | |
|---|---|---|---|---|
| Number | Expiry Date | Renew Date | Date | Status |
| VSML- | Jul. 8, 2008 | Aug. 8, 2008 | Aug. 9, 2008 | Active |
| 0000-001 | | | | |
| VSML- | Jul. 12, 2008 | Aug. 12, 2008 | Aug. 13, 2008 | Lost |
| 0000-0004 | | | | |
| VSML- | Jul. 13, 2008 | Aug. 13, 2008 | Aug. 14, 2008 | Stolen |
| 0000-0007 | | | | |
| VSML- | Jul. 13, 2008 | Aug. 13, 2008 | Aug. 14, 2008 | Cancelled |
| 0000-0008 | | | | |

Each key tag purchased has a one year membership with the lost key rewards system and method. In one embodiment of the invention, the first year of membership may be free while in an alternate embodiment the membership fee is a nominal amount. The expiry date of the key tag is the effective date from which the one year membership renewal date will be calculated. The lost rewards system and method allows the key tag owners one year and thirty days within which to renew their membership without a penalty for reactivating an expired key tag. If the key tag owner wishes to renew the key tag membership beyond the one year and thirty days, the key tag owner will be charged a reactivation fee. Hence, a key tag owner may self-monitor their membership information taking notice of the renewal and reactivation dates to avoid unnecessary costs.

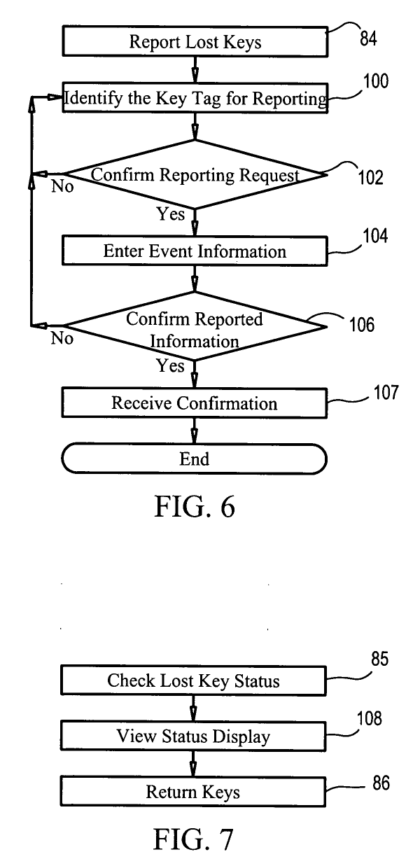

FIG. 6 is a schematic illustration of how to report lost keys using the invention. After accessing the website (step 8, not shown) a key tag owner may opt to report lost keys associated with a particular key tag number to facilitate their return. On occasion a key tag owner may decide not to report the lost or stolen key keys which would not affect the ability of their keys to be found or returned to the key tag owner by the lost key rewards system. The system of the invention would continue to show this key tag in its current status whether active or expired. However, if the key tag owner decides to report the lost or stolen keys, once the option to report lost keys is selected (Step 84), the system of the invention will provide a status display for all key tags owned by this key tag owner. The key tag owner must identify and select the specific key tag number for reporting as in Step 100. The key tag owner may also review and confirm that the correct key tag has been selected as in Step 102 prior to proceeding further with reporting the event. If for any reason an incorrect key tag was selected, the key tag owner may cancel the reporting of that key tag and the key tag owner will be directed back to Step 100 where they may select the correct key tag for processing via Steps 100-107.

If the correct key tag was selected in Step 102, then the key tag owner may proceed with the reporting by entering the event information as in Step 104, i.e. whether the keys were lost or stolen and the date that event occurred. The system of the invention has sufficient protocols and controls to ensure that a date later than the current date cannot be entered as an event date for a lost or stolen key tag. Once again, the key tag owner must confirm the reporting as in Step 106 prior to the database of the invention storing the event information. This extra confirmation step provides a second opportunity to cancel the reporting, in which event, the key tag owner will be directed to Step 100 to follow the steps enumerated in Steps 100-107. However, if the key tag owner is satisfied with the information being reported, the key tag owner can proceed to receive confirmation (Step 107) that the loss event was reported.

FIG. 7 is a schematic illustration of how to check the status of lost keys using the invention. As seen in Step 85, a key tag owner may check the status of their lost or stolen keys to determine whether the keys and the key tag associated with those keys have been found. The system of the invention will display the realtime status information for all applicable key tags owned by the key tag owner. The key tag owner may view the status display as in Step 108 to determine whether their keys have been found, remained lost, or, are in the process of being retrieved from the key tag finder. If the keys have not been found or retrieved from a key tag finder prior to the key tag owner checking the status of the lost keys, the system of the invention will display a message indicating that the keys have not been found, or some other notification of like content and import.

In the alternative, if a key tag finder has already reported the found keys to the lost key rewards system and method (Step 163, not shown), the system of the invention will automatically update its records and database to reflect that information in realtime. In that event, when the key tag owner checks the status for the lost keys (Step 85), the key tag will be reported as being in the process of being retrieved from the key tag finder, or some other like notification of similar content and import. In one embodiment of the invention, the system of the invention provides email notification to the key tag owner as soon as the key tag finder registers the key tag as found with the lost key rewards system and method.

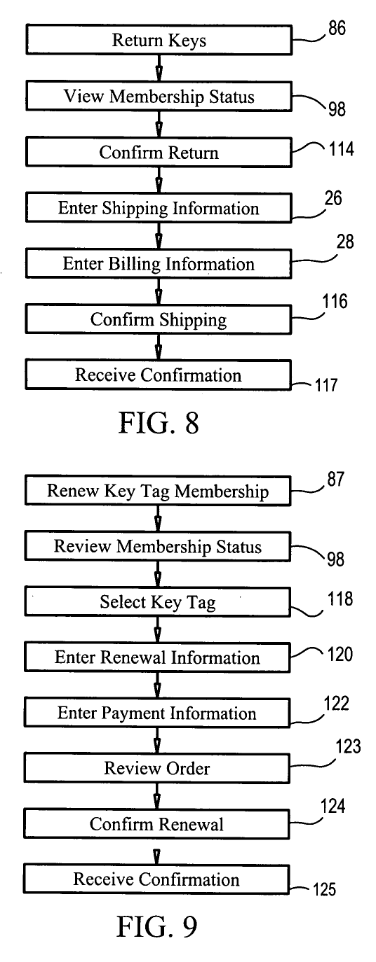

If the keys have been received from the key tag finder but not yet returned to the key tag owner, the key tag will be reported as having been retrieved, or some other message of similar content and import and in addition, the key tag will be flagged for return to the key tag owner. Once the keys are flagged for return, the key tag owner may proceed to process the request to have their keys returned as in Step 86 as seen in FIG. 8.

FIG. 8 is a schematic illustration of the method for the return of found keys using the invention. In one embodiment of the invention, the return of lost keys is a free membership benefit and the key tag owner pays for the shipping and handling for returned keys. In an alternate embodiment, the key tag owner pays a nominal return fee for the key tag's return in addition to the shipping and handling costs. However in both embodiments, if the key tag membership has lapsed and needs to be reactivated or renewed, the key tag owner must pay the reactivation or renewal fee prior to the keys being returned.

Once the key tag owner elects to have their keys returned as in Step 86, the system of the invention will automatically provide an updated status display of their key tag membership information. The key tag owner may then view their key tag membership information as in Step 98 to determine whether or not the key tag membership is active, needs to be renewed, or needs to be reactivated. If thereafter, the key tag owner still wishes to have the keys returned, then the key tag owner must confirm the return request as in Step 114 indicating their acceptance of the various charges, i.e. shipping, reactivation, key tag return or renewal fee, where the key tag owner will be prompted to enter their relevant shipping and billing information as in Steps 26-28 previously described in accordance with FIG. 1. In one embodiment of the invention, the key tag owner is given a second opportunity to confirm their shipping and billing information for the return as in Step 116 prior to finalizing the request. In an alternate embodiment, the shipping and billing information is handled in strict accordance with Steps 26-28 of FIG. 1. In either embodiment, once the shipping and handling have been finalized, the key tag owner may proceed to receive confirmation of the return as in Step 117.

FIG. 9 is a schematic illustration of how to renew a key tag membership using the invention. A key tag will be eligible for renewal at anytime prior to the expiration date, i.e. before the one year and/or any additional grace period have expired. The key tag owner may select to renew their membership as in Step 87 and the system of the invention will automatically display their membership status information for their review.

The key tag owner may then review the membership status information as in Step 98 for the expiry and renewal dates for each key tag owned. Although a key tag owner may own multiple key tags which may have been purchased simultaneously, and thus expires at the same time, a key tag owner can limit their renewal to one or more key tags. To do so, the key tag owner must select the specific key tag(s) that they wish to renew its membership as in Step 118 and proceed to enter the renewal information (Step 120), e.g. number of years to be renewed. Once Step 120 is completed, the key tag owner must enter the payment information (Step 122) for the renewal fees, review the entered payment information (Step 123) and must confirm the renewal as in Step 124. If the key tag owner is satisfied with the renewal request, the key tag owner may proceed to receive confirmation of the renewal as in Step 125.

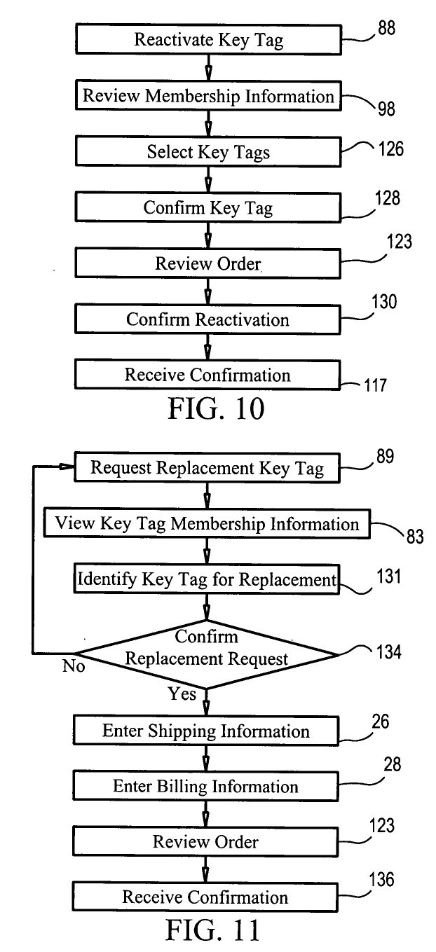

FIG. 10 is a schematic illustration of how to reactivate an expired key tag using the invention. In, in the preferred embodiment, a key tag becomes expired after one year and thirty days. After the one year and thirty days have elapsed, a key tag owner may choose to pay a reactivation fee if the key tag owner wishes to have the specific key tag reflected as in “active” status as in Step 83 of FIG. 5. However, it is not mandatory for the key tag owner to reactivate this specific key tag to remain functional in the lost key rewards system. However, when the lost key tag and keys are found, the key tag owner will have to pay the renewal, reactivation and return key tag fee for that key tag that was not previously reactivated by the key tag owner. Similar to renewing membership, a key tag owner may own multiple key tags that may have expired, however, a key tag owner can limit the reactivation to one or more key tags.

A key tag owner may reactivate an expired key tag as in Step 88 by reviewing their membership information as in Step 98 for accuracy, and affirmatively select the key tag(s) being reactivated as in Step 126. Once Step 126 is completed, the key tag owner must confirm the reactivation request for the specified key tags as in Step 128 and enter the payment information as in Step 129 (not shown). Once the payment information has been entered (Step 129, not shown), the key tag owner must review the order (Step 123) and confirm the accuracy of said information (Step 127, not shown). Prior to finalizing the transaction, the key tag owner is required to again confirm the reactivation (Step 130) of the specified key tag(s) prior to receiving confirmation of the same (Step 117).

FIG. 11 is a schematic illustration of how to request a replacement key tag using the invention. A key tag owner may request a replacement key tag as in Step 89, which in one embodiment of the invention will be free of charge. In an alternate embodiment, the key tag owner will be charged for a replacement key tag. The key tag owner must first review the membership information as in Step 83 for all key tags owned to identify and select the key tag (Step 131) being replaced. Since the key tag number is unique, linked as an identifier to the key tag owner, and used to track membership information, once the key tag owner reports the key tag as damaged, it is desirable that this key tag number be flagged by the system of the invention as being replaced, if not totally eliminated from the system of the invention, such that it can never be reused. Accordingly, prior to the key tag owner replacing the key tag, the key tag owner must confirm the replacement request (Step 134) for the selected key tag.

If the key tag owner chooses to cancel the replacement request, then the system of the invention will abort the replacement request and direct the key tag owner to Step 89 to request the replacement of the correct key tag number. In the alternative, if the key tag owner wishes to continue processing the replacement request, the key tag owner must enter their shipping and billing information in accordance with Steps 26-28 of FIGS. 1 & 11. The key tag owner will be allowed a second opportunity to review the order (Step 123) for a replacement key tag, and if satisfied with the request, proceed to receive confirmation of the replacement request as in Step 136.

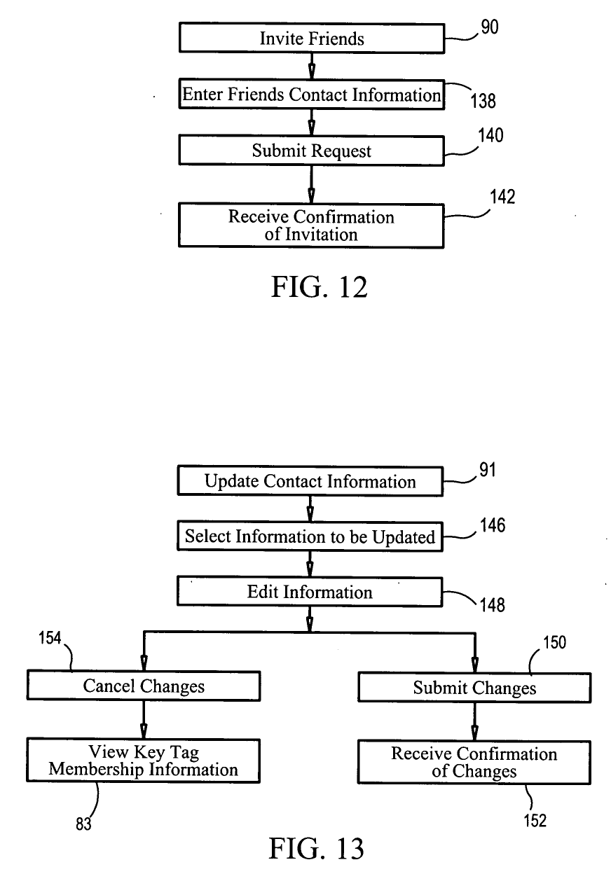

FIG. 12 is a schematic illustration of how a key tag owner may invite friends to become members using the invention. As seen in Step 90, a key tag owner may choose to invite friends to become members of the lost key rewards system and method by entering their friends contact information (Step 138), which may include one or more of the following: name, email address, address, telephone numbers, etc. In one embodiment of the invention, for each friend who elects to become a member, the referring key tag owner receives a promotional incentive, e.g. an additional 30 free days added to one of their key tag membership, or extra chances to participate in promotional giveaways. In an alternate embodiment of the invention, if the key tag owner owns multiple key tags, the key tag owner will receive an additional 30 free days added to key tag membership with the least amount of days remaining prior to expiration.

Once Step 138 is complete, the key tag owner may submit the request as in Step 140 and receive confirmation of the invitation(s) as in (Step 142). In one of the embodiment of the invention, the key tag owner may choose to cancel the request (Step 143, not shown), in which event the key tag owner will receive confirmation of the cancellation request as in Step 144 (not shown). In an alternate embodiment, the key tag owner may elect to omit or remove their friends' contact information, in which event the lost key rewards system will provide notification that none of their friends have been invited or some other notice of like content and import.

FIG. 13 is a schematic illustration of how a key tag owner may update their contact information using the invention. Both the key tag owner who purchased a key tag individually and a key tag owner who gained membership through a corporate rewards program can update their contact information as in Step 91, to ensure that the information being stored on the lost key rewards system and method is current and accurate. As seen in FIG. 13, the key tag owner can select the relevant portion(s) of their contact information (Step 146) that needs to be updated, e.g. email address, name, address, telephone numbers and/or facsimile numbers, or any other relevant contact information. Once selected, the key tag owner may proceed to edit the information as in Step 148. After editing the information (Step 148), and if the proposed changes are correct, the key tag owner may submit the changes as in Step 150 and receive confirmation (Step 152) that the changes were successfully entered. In the alternative, if the key tag owner wishes to cancel or abort the changes at this time, they may do so by canceling the changes as in Step 154 and the system of the invention will direct them to a screen where the key tag owner may view their key tag membership information as in Step 83 for further review.

By using a password verification system that is well known and used in the arts, the key tag owner can change their password as in Step 93 of FIG. 5 in a manner that is well known and used in the arts.

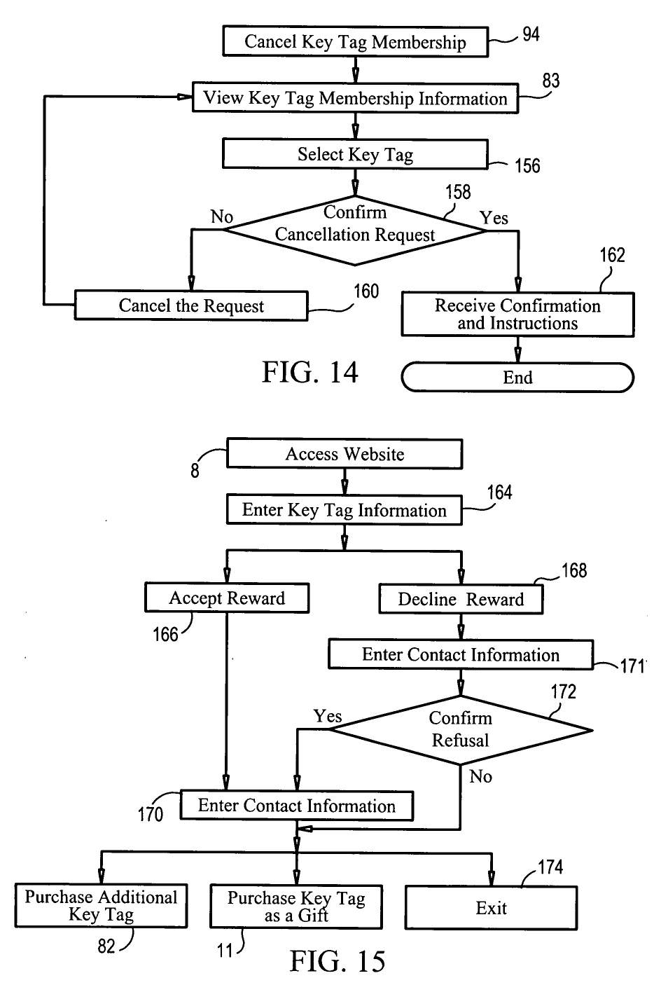

FIG. 14 is a schematic illustration of how a key tag owner may cancel their key tag membership using the invention. A key tag owner may cancel their membership with the lost key rewards system and method without any penalties within the first thirty days after purchasing the key tag. In that event, upon cancellation of the key tag purchase, the key tag owner will be returned their key tag membership and purchase fees, but not the shipping and handling costs. In an alternate embodiment, returns and/or cancellations may be allowed beyond thirty days to conform to international and state laws. As seen in Step 94, the key tag owner can elect to cancel his or her membership for individual key tags. The system of the invention will direct the key tag owner to a screen where the key tag owner may view their key tag membership information as in Step 83. The key tag owner must identify and select the specific key tag(s) (Step 156) for cancellation as identified by the key tag number.

Prior to cancellation, the key tag owner must confirm the cancellation request as in Step 158. If the key tag owner wishes to abort or cancel the cancellation request, the key tag owner may do so by affirmatively canceling the request as in Step 160. In that event, the system of the invention will abort the cancellation for the targeted key tags and return the key tag owner to Step 83. In the alternative, if the key tag wishes to proceed with the cancellation, by submitting the cancellation request as in Step 161 (not shown) the key tag owner receives confirmation of the cancellation (Step 162) and instructions for the key tag's return. Upon cancellation of a key tag's membership, a key tag owner will be required to return the cancelled key tag(s), such that the key tag owner does not unjustly enjoy the benefits of the lost key rewards system and method without paying the appropriate fees. If the key tag owner fails to return the key tag(s) within the specified time, they risk forfeiture of credit and/or additional charges for the unreturned key tag(s).

FIG. 15 is a schematic illustration of how to report found keys using the invention. A key tag finder may access the website using the Internet as seen in Step 8 to report found keys. The key tag finder must identify the found key tag by entering the unique key tag number (Step 164) located on the key tag, if the key tag finder wants to participate in the lost key rewards system and method. However, it is not mandatory for the key tag finder to report the found keys as the key tag finder may simply mail and/or deliver the found key tag and keys to the lost key rewards system and method for its return to its rightful owner. The system of the invention will receive the identification information and will confirm that the key tag number entered is valid and if so, the key tag finder can then choose to either accept the reward (Step 166), or decline the reward (Step 168).

If the key tag finder chooses to participate in the lost key reward program, by accepting the reward (Step 166) they will need to enter their full contact information (Step 170) as in name, address, email address, etc., to direct the reward to an appropriate mailing address. Should the key tag finder elect to decline the reward (Step 168), it would still be helpful to have their contact information for future reference in the event there are problems with the forwarding of the found key tag and keys. Thus, the system of the invention will prompt the key tag finder to enter some contact information as in Step 171. In the preferred embodiment, the key tag finder provides their email and/or their telephone numbers. The key tag finder will also have an additional opportunity to confirm their refusal as in Step 172.

If the key tag owner further declines to participate in the lost key reward system and method, the key tag finder still has an opportunity to either purchase an additional key tag(s) as in Step 82, purchase key tags as gift (Step 11, not shown) or exit the lost key reward system (Step 174). However, if the key tag owner changes their mind and decides to accept the reward, the key tag owner has a second opportunity to do so, and may proceed to enter their contact information as in Step 170 where once completed, they may purchase additional key tags Step 82, purchase key tags as gifts (Step 11) or exit the lost key reward system and method as in (Step 174). However, prior to exiting the lost key rewards system and method the key tag finder will be provided with instructions for forwarding the found keys. In one embodiment of the invention, the system of the invention will promptly notify the key tag owner that the keys have been found as soon as the database of the invention is updated reflecting the same.

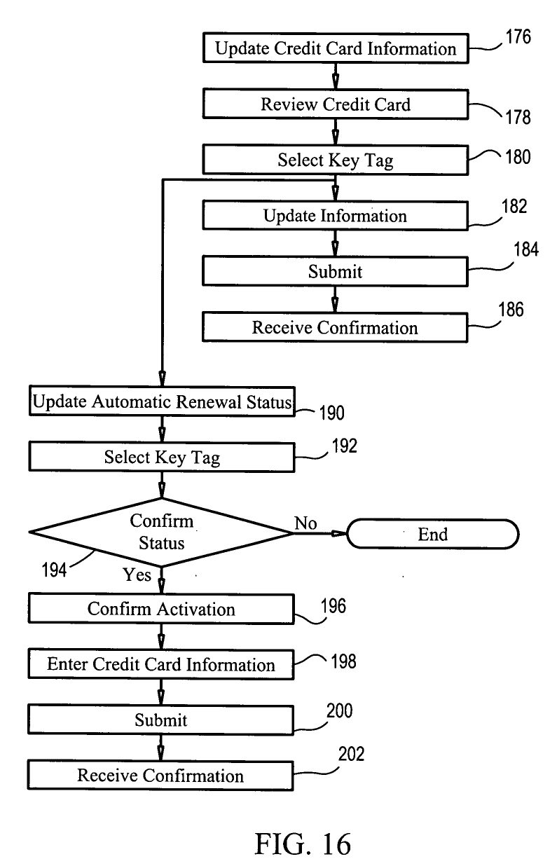

FIG. 16 is a schematic illustration of how a key tag owner may update their credit card information and membership information using the invention. A key tag owner may elect to update their credit card information as in Step 176 and the system of the invention will automatically display their credit card information for each key tag owned. The key tag owner may then review each key tag's credit card information as in Step 178. Similar to the renewal or reactivation of key tags, although a key tag owner may own multiple key tags, the key tag owner can limit the credit card updates to one or more key tags. To do so, the key tag owner must select the specific key tag(s) as in Step 180 that they wish to update and proceed to update the respective credit card information as in Step 182, e.g. type of credit card, credit card number, etc. It is understood that that the system of the invention will provide encryption of the credit card numbers for security purposes as is well known and used in the arts. Once the key tag owner is satisfied that the information entered is correct, the key tag owner may submit the update request as in Step 184 and proceed to receive confirmation (Step 186) of the updated credit card information.

A key tag owner also has the option of automatically renewing their membership (Step 190) with the lost key rewards system and method where the renewal fee is automatically billed to a specified credit card. The key tag owner may enable or disable the automatic renewal by electing to update their automatic renewal status (Step 190) of their yearly membership fee. In that event, the system of the invention will display their renewal status information for each key tag owned. The renewal status information displayed may include but is not limited to, each key tag owned, the credit card number and type, expiration date and the status of the automatic renewal. The key tag owner may then select the key tag(s) (Step 192) being enabled or disabled for automatic renewal and confirm (Step 194) whether or not they would like the automatic renewal status updated. If they choose to disable the automatic renewal function, then there will be no additional charges and no additional input is required. However, the selected key tag where the automatic renewal was disabled will not be automatically renewed once expired.

If the key tag owner chooses to activate the automatic renewal function as in Step 194 then they must confirm the activation as in Step 196, enter their credit card information as in Step 198, submit (Step 200) the credit card information for charges and proceed to receive confirmation of the charges as in Step 202.

Other modifications and implementations will occur to those skilled in the art without departing from the spirit and the scope of the invention as claimed. Accordingly, the invention is to be defined not by the preceding illustrative description but instead by the following claims.

What is claimed is:

1. A method of participating in a lost key rewards program comprising the steps of:
a. accessing a world wide website portal to access a central electronic database;
b. registering at least one key tag and the key tag owner's information with the central electronic database, where each key tag has a unique key tag number; and

2. The method as disclosed in claim 1, further comprising the step of providing known contact information for a third party as the key tag owner.

3. The method as disclosed in claim 2, further comprising the step of entering contact information for the third party to include at least one of: a telephone number, an email address; a shipping address; or an email and shipping address.

4. The method as disclosed in claim 3, further comprising the step of the third party receiving notification of the key tag as a gift.

5. The method as disclosed in claim 1, further comprising the step of entering a temporary password for the key tag number to access the lost key reward system.

6. The method as disclosed in claim 1, further comprising the step of entering corporate passcode to access the electronic database.

7. The method as disclosed in claim 6, further comprising the step of accessing customized confidential information stored on the electronic database by entering a unique passcode.

8. A method of reporting lost keys comprising the steps of:
a. accessing a world wide website portal to access a central electronic database;
b. reporting lost keys by identifying at least one key tag number; and
c. providing lost keys' event information including information respective to at least one of: stolen, lost, and date of loss.

9. A method of reporting found keys comprising the steps of:
a. accessing a world wide website portal to access a central electronic database;
b. reporting found keys by identifying a key tag number for the found keys;
c. entering contact information for a key tag finder; and
d. receiving forwarding instructions for the found keys.

10. The method as disclosed in claim 9, further comprising the step of accepting or declining a reward for finding and returning the found keys.

11. The method as disclosed in claim 10, further comprising the step of requesting an e-commerce transaction to include purchasing at least one key tag.

12. A method of retrieving found keys comprising the steps of:
a. accessing a world wide website to access a central electronic database;
b. determining whether lost keys have been found;
c. determining key tag membership status for a lost key tag associated with the lost keys; and
d. requesting a return of the found keys.

13. The method disclosed in claim 12, further comprising the step of receiving notification of found keys.

14. The method disclosed in claim 12, further comprising the step of determining whether additional fees are required for the return of a found key tag to include any of the following: return key tag fee, key tag renewal fee, reactivation fee, and shipping and handling fees.

15. The method disclosed in claim 12, further comprising the step of providing payment information for the key tag's return.

16. A system for participation in a lost key rewards program comprising:
a. a memory device; and
b. a processor disposed in communication with the memory device, the processor configured to:
i. access a central electronic database;
ii. perform e-commerce transactions including the purchasing at least one key tag; and
iii. register a key tag owner's contact information with the central electronic database.

17. The system as disclosed in claim 16, wherein the processor is further configured to receive contact information for a third party as the key tag owner, to include at least one of: a telephone number, an email address; a shipping address; or an email and shipping address.

18. The system as disclosed in claim 17, wherein the processor is further configured to provide notification of the gift to a third party.

19. The system as disclosed in claim 16, wherein the processor is further configured to perform a random drawing to select a winner from the key tag owners.

20. The system as disclosed in claim 16, wherein the processor is further configured to receive a corporate passcode to access the electronic database.

21. The system as disclosed in claim 20, wherein the processor is further configured to receive a corporate passcode to access customized confidential information stored on the electronic database.

22. A system for the reporting of lost keys comprising:
a. a memory device; and
b. a processor disposed in communication with the memory device, the processor configured to:
i. access a central electronic database;
ii. receive identification of lost key tag number; and
iii. store lost keys' event information.

23. A system for the reporting found keys comprising:
a. a memory device; and
b. a processor disposed in communication with the memory device, the processor configured to:
i. access a central electronic database;
ii. receive identification of a key tag number for the found keys;
iii. receive contact information for a key tag finder; and
iii. provide instructions to key tag finder for the forwarding of found keys.

24. The system as disclosed in claim 23, wherein the processor is further configured to provide notification to key tag owner of found keys.

25. A system for the returning found keys comprising:
a. a memory device; and
b. a processor disposed in communication with the memory device, the processor configured to:
i. access a central electronic database;
ii. identifying key tag owner for found keys;
iii. determine key tag membership status for a lost key tag associated with the lost keys; and
iv. determine whether additional fees are required for the return of a found key tag to include any of the following: return key tag fee, key tag renewal fee, reactivation fee, and shipping and handling fees.

26. The system as disclosed in claim 25, wherein the processor is further configured to receive payment information for the key tag's return.

27. A computer readable medium comprising:
a. instruction code for accessing and updating a database;
b. instruction code for registering key tag owner's and key tag finder's information;
c. instruction code for providing notification; and
e. instruction code for performing e-commerce transactions.

28. The computer readable medium as disclosed in claim 27, the computer readable medium further comprising instruction code for tracking key tag information.

29. The computer readable medium as disclosed in claim 27, the computer readable medium further comprising instruction code for performing random drawings to select a winner from the key tag owners.
